(19) United States
(12) Patent Application Publication
(10) Pub. No.: US 2026/0066195 A1
(43) Pub. Date: Mar. 5, 2026

(54) CONTACT BRIDGE SUB-ASSEMBLY, CONTACT BRIDGE ASSEMBLY AND ELECTRIC SWITCHING DEVICE

(71) Applicants: TE Connectivity Solutions GmbH, Schaffhausen (CH); Tyco Electronics Componentes Electromecanicos Lda, Evora (PT)

(72) Inventors: Katrin SCHERTLER, Berlin (DE); Hugo FONTES, Berlin (DE); António Perdigão DUARTE SILVA, Evora (PT); Tiago TEIXEIRA, Evora (PT)

(21) Appl. No.: 19/311,274

(22) Filed: Aug. 27, 2025

(30) Foreign Application Priority Data
Aug. 29, 2024 (EP) 24398016.6

(51) Int. Cl. H01H 1/20

(52) U.S. Cl. CPC H01H 1/20

(57) ABSTRACT

A contact bridge sub-assembly for an electric switching device such as a relay or a contactor, comprising a contact bridge that is movable along a switching direction, wherein exactly three switching contacts are arranged on the contact bridge, the three switching contacts spanning a contact plane. A contact bridge assembly including such contact bridge sub-assemblies and an electric switching device including at least one contact bridge sub-assembly and/or assembly. The contact bridge sub-assembly reduces electrical losses, heat generation and wear of an electric switching device. At the same time, such electric switching devices are durable, built compactly and cost-effective to manufacture.

### CROSS REFERENCE TO RELATED APPLICATIONS

This application claims the benefit of EP Application Serial No. 24398016.6, filed 29 Aug. 2024, the subject matter of which is herein incorporated by reference in its entirety.

### BACKGROUND OF THE INVENTION

The subject matter herein relates to a contact bridge sub-assembly for an electric switching device such as a relay or a contactor, a contact bridge assembly comprising such contact bridge sub-assemblies, and an electric switching device comprising at least one contact bridge sub-assembly and/or assembly.

Switching devices such as relays or contactors are used to switch electrical currents. To do this, a contact bridge is typically pressed against stationary contacts of the relay or contactor in order to close or open an electrical circuit. In particular when switching high currents, it is important that the transition resistance between switching contacts of the contact bridge and the stationary contacts is minimized in order to reduce electrical losses, heat generation and wear. At the same time, switching devices must be durable, built compactly and cost-effective to manufacture.

### BRIEF DESCRIPTION OF THE INVENTION

In one embodiment, the subject matter herein relates to a contact bridge sub-assembly for an electric switching device such as a relay or a contactor, comprising a contact bridge that is movable along a switching direction, wherein exactly three switching contacts are arranged on the contact bridge, the three switching contacts spanning a contact plane.

In order to establish good electrical contact between the contact bridge and the stationary contacts of the switching device, all contacts of the contact bridge should be in solid contact with the stationary contacts adapted to be contacted by the switching contacts. Failing to do so may, for example, lead to an increase in transition or contact resistance as well as arcing, which may damage the switching device.

The contact bridge sub-assembly provides for a contact bridge with exactly three switching contacts that span a plane, i.e. in particular that are not arranged along a straight line. This ensures that during operation all three contacts make reliable contact with the stationary contacts to be contacted. Similar to a three-legged stool or a tripod, which stand securely even on uneven ground, the three contact-plane-spanning switching contacts make secure contact with the stationary contacts even if the contacts are inaccurately aligned. Such misalignment does not necessarily have to be caused by production-related tolerances, but may also arise due to wear of certain contacts. The contact bridge sub-assembly therefore remains highly functional during operation despite eventual wear.

The contact bridge sub-assembly may be further improved by adding one or more of the features described in the following, whereby each of these features is advantageous in itself, and may be combined independently and/or in any desired manner with any of the other features described herein.

To further improve the electrical contact, at least one, preferably all of the switching contacts may be at least sectionally rounded, curved, arched, concave, convex, or dome-shaped. An apex of such a rounded section of the at least one switching contact may face away from the contact bridge. In a preferred embodiment, all switching contacts are completely rounded.

The switching contacts may be made of or consist of particularly resistant materials intended for conducting high electrical currents, such as AgSnOx, and/or particularly conductive materials suitable for reducing the contact resistance, such as fine-grain silver. Of course, the contacts can be made of different materials.

The switching contacts may be fixed to the contact bridge e.g. via welding, casting, or glueing. In one embodiment, the switching contacts may be monolithically formed with the contact bridge. Of course, other attachment methods may also be provided and the switching contacts may be attached to the contact bridge using different attachment methods.

To save material and thus reduce production costs, according to another embodiment of the contact bridge sub-assembly the contact bridge may comprise at least three legs, wherein each of the switching contacts is arranged on a different leg.

At least one of the switching contacts, preferably all switching contacts may be arranged on free ends of the legs. The free ends may face away from a center of the contact bridge. The center may, for example, be located at the center of gravity of the contact bridge and/or at a point of intersection of longitudinal axes of at least two, preferably of all three legs, on which a switching contact is arranged.

The legs of the contact bridge may have different lengths. In particular, the legs may protrude various distances from the center of the contact bridge. Of course, embodiments where all legs have different or identical lengths are also possible.

The legs of the contact bridge may have different thicknesses and/or widths and/or cross sections. The thickness of a leg may be measured along the switching direction and the cross-section of a leg may be defined by a plane intersecting perpendicularly through the longitudinal axis of the respective leg. The widths of the legs may be measured along a direction extending perpendicularly to the switching direction and the longitudinal axis of the respective leg.

According to a particularly robust embodiment of the contact bridge sub-assembly, at least two of the legs may be joined with each other respectively in at least one joining section. Preferably, all legs of the contact bridge are joined with each other. The connection of the at least two legs is favorably rigid, but may also be flexible or movable.

In one embodiment, the joining section may be configured as a node where all legs of the contact bridge are joined. The joining section or the node, respectively, may, for example, be arranged in the center of the contact bridge. In one embodiment, the contact bridge may comprise a recess and/or an opening that is arranged in the joining section. The opening may at least partially penetrate the contact bridge along the switching direction.

According to a further embodiment, the at least one joining section may be offset along the switching direction relative to the contact plane. The at least one offset joining section may, for example, be or comprise a recess, a hollow, a depression, or a cavity. With these configurations, the contact bridge may be designed to accommodate further elements, making the contact bridge sub-assembly more compact.

In a stable and easy-to-manufacture embodiment of the contact bridge sub-assembly, the contact bridge may have a Y-shape. In particular, the legs on which the contacts are located may be arranged in a Y-shape. In another embodiment, the contact bridge, in particular the legs on which the switching contacts are arranged, may have the shape of a tuning fork. At least all legs provided with a switching contact may extend parallel to each other.

According to another advantageous embodiment, the contact bridge sub-assembly may comprise a spring assembly which supports the contact bridge, the spring assembly comprising at least one spring element. This ensures that the contact bridge is pressed sufficiently strongly against the stationary contacts during operation to provide good electrical contact.

At least one spring element of the spring assembly may be supported or rest on the side of the contact bridge facing away from the switching contacts. At least one spring element of the spring assembly may be fixed to the contact bridge. At least one spring element of the spring assembly may be fixed to the contact bridge via a form-fit, for example with the spring element engaging a recess of the contact bridge. Additionally or cumulatively, a friction lock between at least one spring element of the spring assembly and the contact bridge may be provided, for example through friction-enhancing surfaces on the spring element and/or the contact bridge. Further, material locking such as welding or bonding may be used to fix at least one spring element of the spring assembly to the contact bridge. Of course, combinations of different fixing methods are conceivable, for example in the form of a screw connection.

In another embodiment, at least one spring element, preferably all spring elements of the spring assembly are movably arranged on the contact bridge. In this case, the contact bridge and/or the at least one spring element of the spring assembly may comprise a friction-reducing surface at least in the area where the spring element is supported or, synonymously, rests on the contact bridge.

In a preferred embodiment, at least one spring element of the spring assembly is or comprises a coil spring, a leaf spring, or a flat spring. If more than one spring element is provided, different spring types may be used for the spring elements. For example, one spring element may be a leaf spring, another spring element may be a flat spring, and yet another spring element may be a coil spring. The spring elements may be connected in series and/or in parallel. The spring elements may have different spring stiffnesses or all spring elements may have the same spring stiffness.

A spring element may consist of at least two individual (sub-) springs connected in series and/or in parallel. These individual springs may be-analogue to the above explanations on the spring elements-variously configured.

According to a further embodiment of the contact bridge sub-assembly, at least one of the at least three legs may be supported by at least one spring element of the spring assembly. This is a particularly reliable way of ensuring that at least the switching contact being arranged on the supported leg makes full contact with the stationary contacts during operation.

All legs on which a switching contact is arranged may be supported by at least one spring element of the spring assembly. At least two of the spring elements by which different legs are supported may be joined with, or, synonymously, connected to each other, for example by a welded or screw connection. In one embodiment, at least two spring elements by which different legs are supported may be integrally formed with each other.

To reduce production costs, a spring element or at least two joined spring elements may be made from a stamped and bent metal part.

In a particularly advantageous embodiment of the contact bridge sub-assembly, the spring assembly may comprise at least two spring elements that are deflectable independent of each other. This configuration allows the contact bridge to be supported by the spring elements to different degrees at different points. For example, at least two legs of the contact bridge, which each have switching contacts, may be supported independent of each other, which improves the electrical contact at each of the switching contacts.

In one embodiment, the spring assembly may comprise multiple spring elements that are all deflectable independent of one another. Each of the legs on which a switching contact is arranged may be supported by a spring element that are deflectable independent of each other. Of course, it is also conceivable that at least one of the legs is provided with two or more spring elements that are deflectable, or, synonymously, deformable independent of each other. Of course, legs on which no switching contact is arranged may also comprise at least one spring element.

To distribute the mechanical loads between the spring elements and to increase buckling safety, the contact bridge sub-assembly may comprise at least one stiffening member for supporting the spring assembly, and each spring element of the spring assembly may comprise two support sections at opposite ends, one support section being located at the contact bridge and the other support section being connected to the stiffening member. The stiffening member may be adapted for at least partially receiving the mechanical loads of the at least two spring elements and/or for stabilizing the spring elements. The stiffening member may have a greater hardness and/or stiffness and/or material thickness than the at least one spring element of the spring assembly. In various embodiments, the at least one stiffening member may be connected to the spring assembly by welding, riveting, screwing or bonding. Of course, a single spring element of the spring assembly may be connected to the stiffening member using a combination of the above fastening methods. Different spring elements of the spring assembly may be connected to the stiffening member using different types of fastening.

In one embodiment, the stiffening member may be monolithically formed with at least one spring element of the spring assembly, preferably with all spring elements of the spring assembly. In a low-cost design, the stiffening member may be made of a stamped and bent metal part such as a metal sheet.

In one embodiment, all spring elements of the spring assembly may be connected via a single stiffening member. At least two, preferably all spring elements by which different legs of the contact bridge are supported may be joined by the stiffening member.

In order to bias the spring assembly of the contact bridge sub-assembly and thus be able to set a predetermined resistance force of the switching contacts during opening or closing, the contact bridge sub-assembly may comprise at least one contact bridge retainer adapted for holding the contact bridge against the direction of action of the spring assembly.

The contact bridge retainer may be provided for pretensioning the spring assembly. To do so, the contact bridge retainer may hold the contact bridge at a predetermined distance from the end of the at least one spring element facing away from the contact bridge. The distance thereby may be measured along the switching direction.

The stiffening member and/or the contact bridge retainer and/or the at least one spring element of the spring assembly may be integrally formed with each other, and/or may be made e.g. from a stamped and bent metal part such as a metal sheet. To electrically decouple the contact bridge from other components of the contact bridge sub-assembly and/or from components interacting with or surrounding the contact bridge sub-assembly, the contact bridge sub-assembly may comprise at least one insulating body. The at least one stiffening member and/or contact bridge retainer and/or spring assembly may be at least sectionally embedded in, in particular overmolded by the insulating body. At least one spring element of the spring assembly may be embedded in the insulating body on the end of the at least one spring element facing away from the contact bridge.

The insulating body may at least sectionally, preferably completely, be made of an insulating material and may be shaped in various ways, e.g. as a plate or block.

If the electrical decoupling is achieved otherwise, for example in another location within the relay, the insulating body may be omitted, such that the contact bridge sub-assembly comprises no insulation element at all.

In one embodiment, the subject matter herein relates to a contact bridge assembly comprising a first contact bridge sub-assembly and a second contact bridge sub-assembly. Such a contact bridge assembly lowers the electrical contact resistance by proving three additional switching contacts. At the same time, the possibility is opened up that the switching contacts of the first contact bridge sub-assembly open or close at a different time than the switching contacts of the second contact bridge sub-assembly.

The contact plane spanned by the switching contacts of the first contact bridge sub-assembly may extend parallel to the contact plane spanned by the switching contacts of the second contact bridge sub-assembly. In another embodiment, the contact plane spanned by the switching contacts of the first contact bridge sub-assembly may be identical to the contact plane spanned by the switching contacts of the second contact bridge sub-assembly.

In a cost-effective embodiment, the contact bridge of the first contact bridge sub-assembly and the contact bridge of the second contact bridge sub-assembly may be formed identically except for the arrangement of the switching contacts. The contact bridges may have identical base bodies, wherein the base bodies correspond to the contact bridges on which no switching contacts are arranged.

In one embodiment, the contact bridge of the first contact bridge sub-assembly and the contact bridge of the second contact bridge sub-assembly may have different lengths and/or thicknesses. The thicknesses may be measured along the switching direction. The lengths may be measured perpendicular to the switching direction.

To make the contact bridge assembly compact and robust, the contact bridges of the first and the second contact bridge sub-assemblies may be interlaced. The contact bridges may also be interlocked, intertwined and/or inserted, embedded or set into each other and/or fitted together. The contacts bridges may advantageously be interlaced in the at least one joining section. The contact bridges of the first and the second contact bridge sub-assemblies may at least sectionally, in particular in the at least one joining section, overlap along the switching direction.

In one embodiment, the contact bridge of the first contact bridge sub-assembly may be formed straight, i.e. without an offset joining section, and the contact bridge of the second contact bridge sub-assembly may have a joining section that is offset along the switching direction relative to the contact plane of the second contact bridge assembly. In this particular embodiment, the joining section of the contact bridge of the first contact bridge sub-assembly may be arranged in the offset joining section of the contact bridge of the second contact bridge sub-assembly.

In a preferred embodiment, both contact bridges may have complimentary formed offset joining sections in which the contact bridges overlap and/or are interlocked. Complementary offset joining sections may be present in particular if the contact bridges are formed identically except for the switching contacts.

The contact bridge of the first contact bridge sub-assembly may be spaced apart from the contact bridge of the second contact bridge sub-assembly along the switching direction at least in the area of the joining sections. This means that there may be a gap extending in the switching direction between the two contact bridges, at least in the area of the joining sections.

A particularly compact design of the contact bridge assembly and a dense arrangement of the switching contacts is achieved according to a further embodiment of the contact bridge assembly, wherein a leg of the contact bridge of the first contact bridge sub-assembly may at least sectionally be arranged between two legs of the contact bridge of the second contact bridge sub-assembly.

A leg of the contact bridge of the first contact bridge sub-assembly may at least sectionally penetrate a gap between two legs of the contact bridge of the second contact bridge sub-assembly.

The leg of the contact bridge of the first contact bridge sub-assembly that is arranged between two legs of the contact bridge of the second contact bridge sub-assembly may be longer and/or project further outwardly than at least one of the legs of the contact bridge of the second contact bridge sub-assembly, between which the leg of the first contact bridge sub-assembly is arranged.

Analogously, the leg of the contact bridge of the first contact bridge sub-assembly that is arranged between two legs of the contact bridge of the second contact bridge sub-assembly may have a larger width and/or thickness and/or cross-section than at least one of the legs of the contact bridge of the second contact bridge sub-assembly, between which the leg of the first contact bridge sub-assembly is arranged.

According to a further embodiment, at least one spring element may support the contact bridges of both the first and the second contact bridge sub-assembly. In this way, the construction effort, the material input and thus the costs of the contact bridge assembly can be reduced.

In a particularly cost-effective embodiment, only a single spring element may be provided to support the contact bridge of both the first and the second contact bridge sub-assembly.

The at least one contact bridge retainer of the first contact bridge sub-assembly may be the same component as the at least one contact bridge retainer of the second contact bridge sub-assembly. Consequently, the contact bridge assembly may only comprise a single contact bridge retainer, which holds both the contact bridge of the first contact bridge sub-assembly and the contact bridge of the second contact bridge sub-assembly against the direction of action of the at least one spring element.

Analogously, the at least one stiffening member of the first contact bridge sub-assembly may be the same component as the at least one stiffening member of the second contact bridge sub-assembly. The contact bridge assembly thus may only comprise a single stiffening member.

Similarly, the at least one insulating body of the first contact bridge sub-assembly may be the same component as the at least one insulating body of the second contact bridge sub-assembly, such that the contact bridge assembly may comprise only a single insulating body.

In one embodiment, the subject matter herein relates to an electric switching device, wherein the switching device may comprise at least one contact bridge sub-assembly and/or at least one contact bridge assembly; a drive shaft adapted for moving the contact bridges jointly along the switching direction; and stationary contacts that are configured to be contacted by the switching contacts.

The switching contacts and the stationary contacts may together constitute an electrical circuit.

The contact bridge or the contact bridges, respectively, may be movable relative to the drive shaft. For example, the contact bridge or the contact bridges, respectively, may be rotatable about a longitudinal axis of the drive shaft and/or be pivotable about at least one pivot axis extending perpendicular to the longitudinal axis of the drive shaft. It is also conceivable that the contact bridge or the contact bridges, respectively, may be movable, in particular displaceable perpendicular to the longitudinal axis of the drive shaft.

The at least one spring element, in particular its end facing away from the contact bridge or the contact bridges, respectively, may be at least indirectly supported on the drive shaft, such that the direction of action of the at least one spring element pushes the contact bridge or the contact bridges, respectively, and the drive shaft apart. The direction of action of the at least one spring element may extend along the switching direction.

In one embodiment, the drive shaft may directly be attached or connected to the at least one stiffening member and/or to the at least one spring element. In this embodiment, no insulating body may be present at all.

The drive shaft may at least sectionally be embedded in, advantageously overmolded by, the insulating body in order to electrically decouple the contact bridge or the contact bridges, respectively, from the drive shaft. A head of the drive shaft may be embedded in the insulating body, the head of the drive shaft being located at an end of the drive shaft facing the contact bridge or the contact bridges, respectively. In the following, the subject matter herein is explained exemplarily in more detail with reference to the drawings and in accordance with several embodiments, the different features of which can be combined with one another as desired in accordance with the above general description. Moreover, a feature may be omitted from the below embodiments if its technical effect is not required in a particular application. Likewise, a feature described above that is not present in an embodiment as described below may be added if its technical effect is essential for a particular application.

In the following, the same reference numerals are used for elements that correspond to each other with respect to at least one of structure and function.

### BRIEF DESCRIPTION OF THE DRAWINGS

Described herein are:

FIG. 1 a schematic perspective view of a contact bridge sub-assembly according to a possible embodiment;

FIG. 2 a schematic perspective view of a contact bridge assembly according to a possible embodiment;

FIG. 3 a schematic perspective view of a contact bridge assembly according to yet another embodiment;

FIG. 4 a schematic perspective view of a contact bridge assembly according to yet another embodiment;

FIG. 5 a schematic perspective view of an electric switching device according to a possible embodiment;

FIG. 6 a schematic perspective view of a contact bridge assembly according to yet another embodiment;

FIG. 7 a sectional view of the contact bridge assembly shown in FIG. 6;

FIG. 8 a sectional view of an electric switching device according to another possible embodiment in an open state;

FIG. 9 a sectional view of the electric switching device shown in FIG. 8 in a partially closed state; and

FIG. 10 a sectional view of the electric switching device shown in FIG. 8 in a closed state.

### DETAILED DESCRIPTION OF THE INVENTION

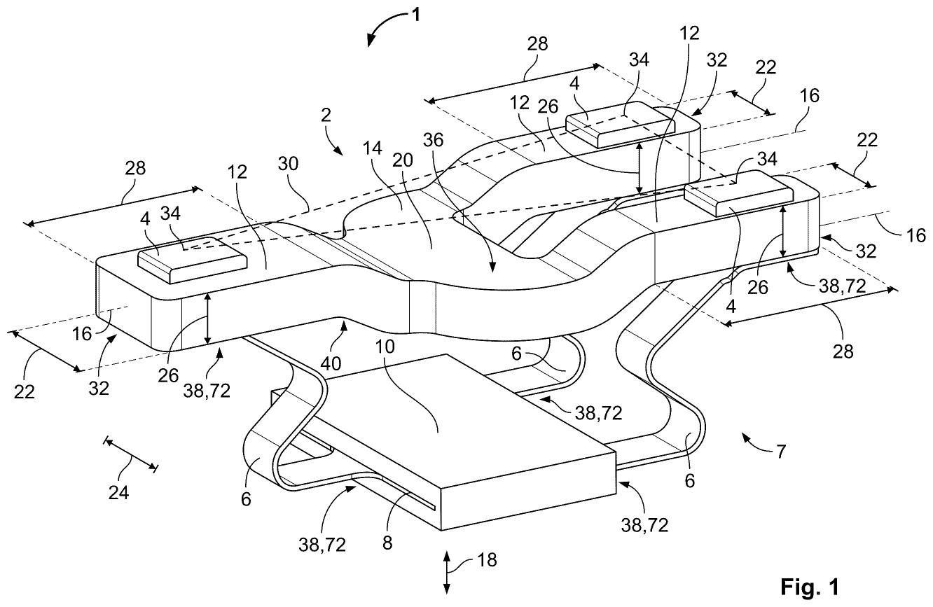

FIG. 1 shows a contact bridge sub-assembly according to a possible embodiment. The contact bridge sub-assembly 1 of the embodiment of FIG. 1 comprises a contact bridge 2, three switching contacts 4, a spring assembly 7 comprising three spring elements 6, a stiffening member 8, and an insulating body 10.

In the embodiment shown in FIG. 1, the contact bridge 2 has a Y-shape, or, synonymously, the shape of a tuning fork. The contact bridge 2 may comprise three legs 12 that are joined with each other in a joining section 14. In the shown embodiment, longitudinal axes 16 of the legs 12 extend parallel to each other and perpendicular to a switching direction 18, along which the contact bridge 2 is movable. Of course, the contact bridge 2 may also have a different shape than the contact bridge 2 shown in FIG. 1, e.g. a star shape. In such an embodiment, the longitudinal axes 16 of the legs 12 may intersect at a common point that may, for example, be located in a center 20, in particular in a center of gravity, of the contact bridge 2.

In the embodiment shown in FIG. 1, the legs 12 have different widths 22 along a width direction 24. The width direction 24 may extend perpendicular to the longitudinal axis 16 of the respective leg 12 and perpendicular to the switching direction 18. The legs 12 of the contact bridge 2 may have, as shown in FIG. 1, a same thickness 26 measured along the switching direction 18. In addition, in the example shown, the legs 12 have a length 28 that is measured along the longitudinal axes 16 of the respective leg 12. In the embodiment shown in FIG. 1, all the legs 12 have the same length 28. In other embodiments, at least two of the legs 12 may have different lengths 28 and/or thicknesses 26. Similarly, in some embodiments, all legs 12 may have the same width 22.

The contact bridge 2 is provided with exactly three switching contacts 4. The switching contacts 4 span a contact plane 30. In the embodiment shown in FIG. 1, each switching contact 4 is located on a free end 32 of the respective leg 12 of the contact bridge 2. Of course, the switching contacts 4 may also be located at other locations on the contact bridge 2, in particular at other locations on the legs 12. Not all of the switching contacts 4 necessarily have to be arranged on a separate leg 12, but two or three switching contacts 4 may also be arranged on a common leg 12.

To improve the electrical contact, the switching contacts 4 of the embodiment of FIG. 1 are shaped slightly rounded, comprising an apex 34 facing away from the contact bridge 2. Of course, the switching contacts 4 may also be rounded only in sections or be flat. A differently shaped rounding, for example dome-shaped switching contacts 4, is also conceivable. The material of the switching contacts 4 is of course not visible in FIG. 1. However, it should be mentioned that the switching contacts 4 may be made of or consist of materials intended for conducting high electrical currents, such as AgSnOx, and/or particularly conductive materials such as finegrain silver. Of course, the switching contacts 4 may be made of different materials.

Whereas the number of switching contacts 4 must be exactly three according to an embodiment, the number of legs 12 comprised by the contact bridge 2 may be variable. Thus, according to different embodiments, the contact bridge 2 may have fewer than three legs 12, such that not each of the three switching contacts 4 is arranged on a separate leg 12. Similarly, more legs 12 may be provided, for example four or five legs 12. In other embodiments, the contact bridge 2 may comprise no legs 12 at all.

In the embodiment shown in FIG. 1, the joining section 14, in which the legs 12 of the contact bridge 2 are joined in a node, is offset relative to the contact plane 30 spanned by the switching contacts 4. As shown in FIG. 1, the offset joining section 14 may form a depression 36 in the contact bridge 2 into which other elements, e.g. parts of another contact bridge 2, may be inserted.

Not all of the legs 12 of the contact bridge 2 must be joined, or, synonymously, connected to each other via the joining section 14. For example, it is also possible that the joining section 14 only joins two of the legs 12 with each other. Unlike shown in FIG. 1, several, e.g. two or three joining sections 14 may be provided. In one embodiment, the legs 12 that are connected via a joining section 14 may additionally be joined to each other via at least one further joining section 14. Nevertheless, in another embodiment, one of the joining sections 14 may connect other legs 12 to each other than at least one other joining section 14. Several joining sections 14 may be connected to each other.

In the embodiment shown in FIG. 1, the legs 12 are rigidly joined with each other in the joining section 14. In the contact bridge sub-assembly 1 of FIG. 1, this rigid connection results from the fact that the contact bridge 2 is—apart from the switching contacts 4—monolithically formed. Of course, the legs 12 may also be firmly joined together in the joining section 14 in other ways, e.g. by welding or glueing. Instead of a rigid connection as shown in FIG. 1, at least two of the legs 12 may be connected to each other in the joining section 14 in a movable, e.g. displaceable and/or swivelling and/or resilient manner. In a further embodiment, at least one of the legs 12 may be detachably and/or interchangeably attached to the joining section 14.

As seen in FIG. 1, each of the legs 12 may be supported by a spring element 6 of the spring assembly 7, which are designed here as a flat spring purely by way of example. In other embodiments, other spring types such as leaf springs or coil springs may be provided. Of course, if two or more spring elements 6 are provided, the spring elements 6 may have different spring types. A single spring element 6 may also consist of several (sub-) springs, each of which may have different spring types.

In the embodiment of FIG. 1, all spring elements 6 are deflectable independent of each other, so that each of the legs 12 and thus the switching contacts 4 of the contact bridge 2 is supported independent of the other legs 12 or switching contacts 4, respectively. In other embodiments, of course, the spring elements 6 may be arranged in such a way that they can only be deflected together.

In the embodiment shown in FIG. 1, the spring elements 6 each comprise two support sections 38 at opposite ends 72 of the respective spring element 6. One support section 38 may rest on a side 40 of the contact bridge 2 facing away from the switching contacts 4. In particular, each of the support sections 38 arranged on the contact bridge 2 may rest on the free end 32 of a leg 12 of the contact bridge 2. In the embodiment shown in FIG. 1, the support sections 38 that are arranged on the contact bridge 2 are firmly connected to the legs 12 of the contact bridge 2. Welded, riveted, screwed or soldered connections, for example, are conceivable as fastening methods. In other embodiments, at least one spring element 6, preferably all spring elements 6 may be movably arranged on the contact bridge 2. Particularly in this case, a contact bridge retainer 42 may, as shown in the embodiment of FIG. 4, be provided, the contact bridge retainer 42 being adapted for holding the contact bridge 2 against a direction of action 44 of the spring elements 6. The structure and function of the contact bridge retainer 42 is described in more detail later.

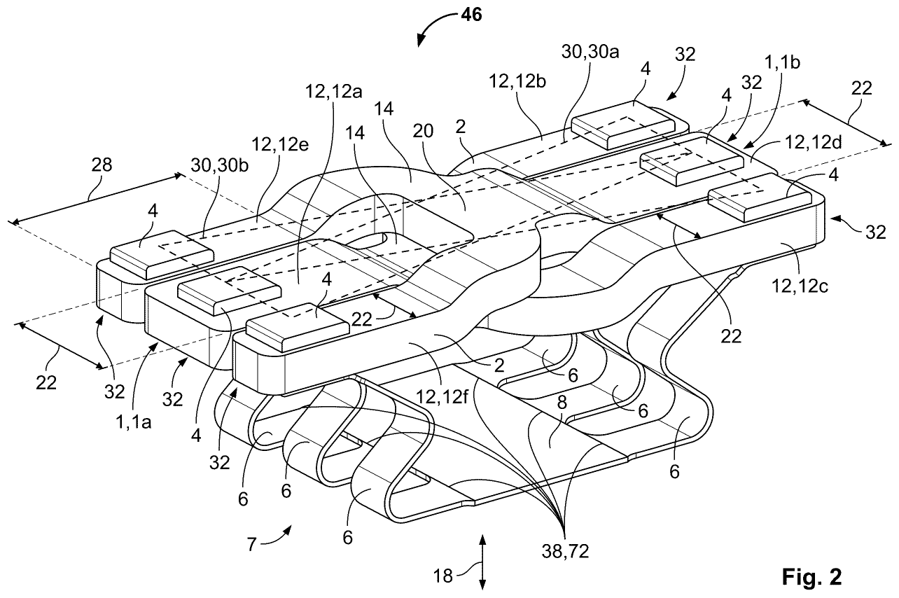

In the embodiment of FIG. 1, all support sections 38 facing away from the contact bridge 2 are connected to the stiffening member 8 and thus with each other. The stiffening member 8 may be adapted for at least partially receiving the mechanical loads such as bending moments of the spring elements 6 and/or for distributing said loads among the spring elements 6. This may make the spring elements 6 less likely to reduce force due to positional offsets of the switching contacts 4. In the embodiments shown in FIGS. 1 and 2, the stiffening member 8 is formed as a plate that extends along the contact plane 30 spanned by the switching contacts 4. Of course, the stiffening member 8 may also be shaped differently in other embodiments, for example as a block.

To electrically decouple the contact bridge 2 from other components potentially interacting with the contact bridge sub-assembly 1, the contact bridge sub-assembly 1 shown in FIG. 1 comprises the insulating body 10. In the shown embodiment, the stiffening member 8 is embedded in the insulating body 10, whereas the support sections 38 facing away from the contact bridge 2 are not enclosed by the insulating body 10. In other embodiments, the spring elements 6 of the spring assembly 7 may be received in the insulating body 10 at least at their support sections 38 facing away from the contact bridge 2.

FIG. 2 shows a contact bridge assembly 46 according to a possible embodiment. The contact bridge assembly 46 comprises a first contact bridge sub-assembly 1, 1a and a second contact bridge sub-assembly 1, 1b. The contact bridge 2 of the first contact bridge sub-assembly 1, 1a may be identical to the contact bridge 2 of the contact bridge sub-assembly 1 shown in FIG. 1. The contact bridge 2 of the second contact bridge sub-assembly 1, 1b may be—except for the arrangement of the switching contacts 4—identical to the contact bridge 2 of the first contact bridge sub-assembly 1, 1a.

As in the embodiment shown in FIG. 2, both contact bridges 2 have exactly three switching contacts 4, each of which is arranged at the free end 32 of a leg 12. The switching contacts 4 of the contact bridge 2 of the first contact bridge sub-assembly 1, 1a span a first contact plane 30, 30a, and the switching contacts 4 of the contact bridge 2 of the second contact bridge sub-assembly 1, 1b span a second contact plane 30, 30b. In an unloaded state of the contact bridge assembly 46 as shown in FIG. 2, the first and second contact planes 1, 1a, 1b may extend parallel to each other.

In the embodiment shown in FIG. 2, the contact bridge 2 of the first contact bridge sub-assembly 1, 1b and the contact bridge 2 of the second contact bridge sub-assembly 1, 1b are intertwined, such that the joining sections 14 of both contact bridges 2 overlap each other along the switching direction 18. Furthermore, a first leg 12, 12a of the contact bridge 2 of the first contact bridge sub-assembly 1, 1a may be arranged between a second leg 12, 12e, and a third leg 12, 12f of the contact bridge 2 of the second contact bridge sub-assembly 1, 1b, and a first leg 12, 12d of the contact bridge 2 of the second contact bridge sub-assembly 1, 1b is arranged between a second leg 12, 12b and a third leg 12, 12c of the contact bridge 2 of the first contact bridge sub-assembly 1, 1a. In the embodiment shown in FIG. 2, the first legs 12, 12a, 12d of both contact bridges 2 have a larger width than the second and third legs 12, 12b, 12c, 12e, 12f of the contact bridges 2.

In other embodiments, the contact bridge assembly 46 may comprise contact bridge sub-assemblies 1, 1a, 1b having contact bridges 2 that are shaped differently. As an example only, the first leg 12, 12a of the contact bridge 2 of the first contact bridge sub-assembly 1, 1a may have a greater length 28 than the second leg 12, 12e and/or third leg 12, 12f of the contact bridge 2 of the second contact bridge sub-assembly 1, 1b. In particular, the free end 32 of the first leg 12, 12a of the contact bridge 2 of the first contact bridge sub-assembly 1, 1a may protrude further away from the centers 20 of the contact bridges 2 than the free ends 32 of the second leg 12, 12e and/or third leg 12, 12f of the contact bridge 2 of the second contact bridge sub-assembly 1, 1b.

In the embodiment shown in FIG. 2, each of the legs 12, 12a-f of the contact bridges 2 of the first and second contact bridge sub-assembly 1, 1a, 1b is supported by a spring element 6 of the spring assembly 7. Similar to the embodiment shown in FIG. 1, all spring elements 6 are deflectable independent of each other. The contact bridge assembly 46 of FIG. 1 comprises a single stiffening member 8, with which all spring elements 6 are joined via their support sections 38 facing away from the contact bridges 2.

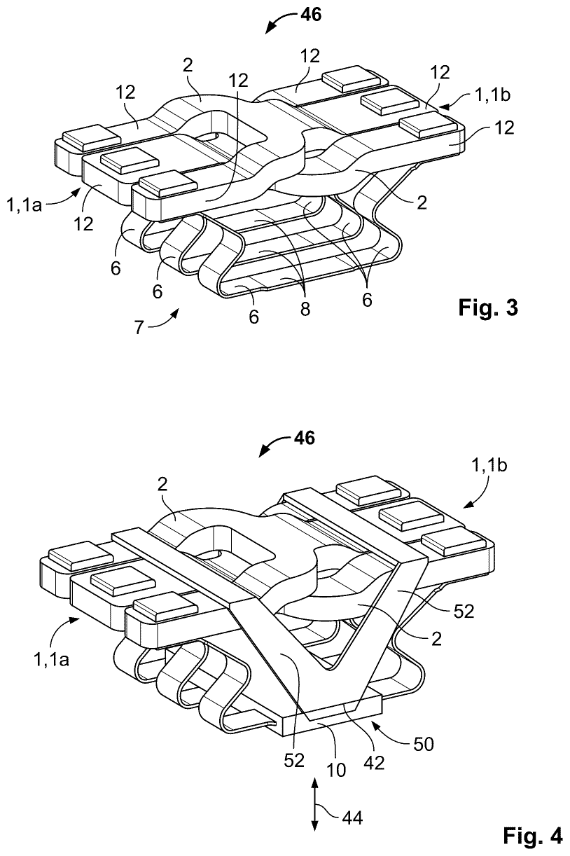

As seen in FIG. 3, not all spring elements 6 of the spring assembly 7 must be joined with a single stiffening member 8. In the embodiment of the contact bridge assembly 46 shown in FIG. 3, three stiffening members 8 are provided that are each joined with both a leg 12 of the contact bridge 2 of the first contact bridge sub-assembly 1, 1a and a leg 12 of the contact bridge 2 of the second contact bridge sub-assembly 1,1b.

The contact bridge assembly 46 shown in FIG. 4 is substantially identical to the contact bridge assembly 46 according to FIG. 3. The contact bridge assembly 46 according to FIG. 4, however, includes an insulating body 10 and a contact bridge retainer 42. As shown, the stiffening members 8 may be fully embedded in the insulating body 10. In the shown embodiment, the insulating body 10 is adapted to electrically decouple both the contact bridge 2 of the first contact bridge sub-assembly 1,1a and the contact bridge 2 of the second contact bridge sub-assembly 1, 1b from other components. The insulating body 10 may thus be part of both the first and the second contact bridge sub-assembly 1, 1a, 1b.

As further shown in FIG. 4, the contact bridge retainer 42 may at least partially be embedded in the insulating body 10, particularly at an end 50 of the contact bridge retainer 42 facing away from the contact bridges 2. In the embodiment shown, the contact bridge retainer 42 comprises two brackets 52 arranged in a V-shaped manner to each other, which embraces the contact bridges 2 of both the first and second contact bridge sub-assembly 1, 1a, 1b. In this way, the contact bridge retainer 42 may hold both contact bridges 2 against the direction of action 44 of the spring elements 6. Of course, the arrangement of the brackets 52 is not limited to the above-mentioned V-shape. In other embodiments, other arrangements of the brackets 52 are also conceivable, for example a U-shape or Z-shape.

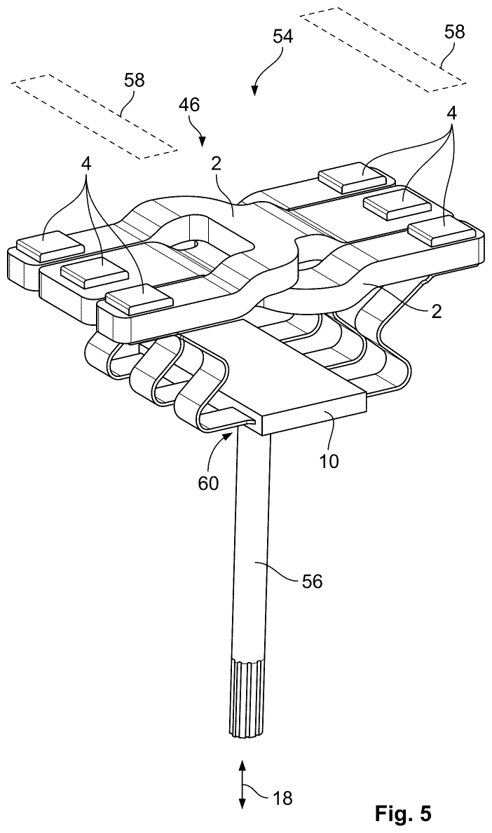

FIG. 5 shows an electric switching device 54 according to a possible embodiment. The electric switching device 54 comprises a contact bridge assembly 46, a drive shaft 56 and stationary contacts 58. Apart from the fact that no contact bridge retainer 42 is provided, the contact bridge assembly 46 shown in FIG. 5 is otherwise identical to the contact bridge assembly 46 described with reference to FIG. 4. In the embodiment of FIG. 5, a head 60 of the drive shaft 56 is accommodated in the insulating body. The head may, for example, be overmoulded by the insulating body 10.

The drive shaft 56 may be adapted for moving the contact bridges 2 jointly along the switching direction 18. To switch the electric switching device 54, the contact bridges 2 may be moved jointly along the switching direction 18. To close the switching device 54 and thus the electrical circuit, the contact bridges 2 may be moved together towards the stationary contacts 58 until the switching contacts 4 are in contact with the stationary contacts 58 to be contacted. To open the electric switching device 54 and thus break the electrical circuit, the contact bridges 2 may be jointly moved away from the stationary contacts 58 until the switching contacts 4 no longer make contact with the stationary contacts 58.

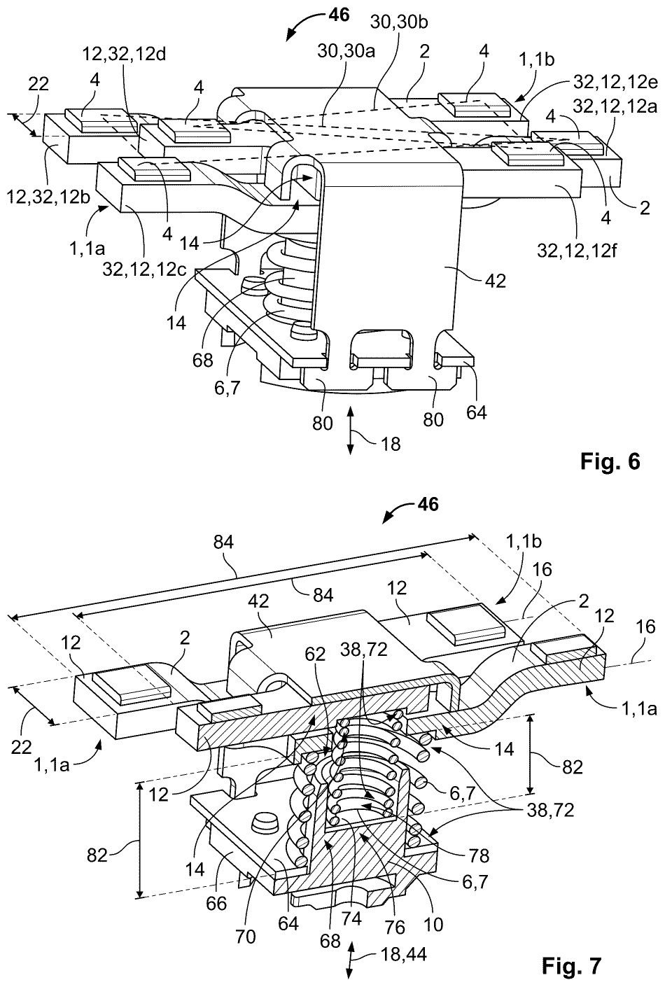

FIGS. 6 and 7 show a contact bridge assembly 46 according to another possible embodiment. The shown contact bridge assembly 46 comprises a first and a second contact bridge sub-assembly 1, 1a, 1b.

The first contact bridge sub-assembly 1, 1a comprises a contact bridge 2 that is structured similar to the contact bridge 2 of the second contact bridge sub-assembly 1, 1b shown in FIG. 2. Briefly, the contact bridge 2 of the first contact bridge sub-assembly 1, 1a shown in FIGS. 6 and 7 has a Y-shape and comprises three legs 12. The contact bridge 2 is provided with exactly three switching contacts 4 that, in the shown embodiment, are each arranged at a free end 32 of a different leg 12 and span a first contact plane 30, 30a. As further seen in FIGS. 6 and 7, the legs 12 of the contact bridge 2 of the first contact bridge sub-assembly 1, 1a may be joined in a joining section 14, that, in the shown embodiment, is offset along the switching direction 18 and relative to the first contact plane 30, 30a.

The first contact bridge sub-assembly 1, 1a may further comprise spring assembly 7 having a spring element 6 which, in the embodiment shown, may not be configured as a flat spring, but as a coil spring. The spring element 6 may include two support sections 38, one of which may rest in a first circular recess 62 formed in the contact bridge 2 of the first contact bridge sub-assembly 1,1a. The other support section 38 of the spring element 6 may rest on a first pressure plate 64, which, in the embodiment of FIGS. 6 and 7, may be arranged on a base section 66 of the insulating body 48. The base section 66 of the insulating body 48 may extend substantially parallel to the first contact plane 30, 30a. The spring element 6 may, along the direction of action 44 of the spring element 6, push the contact bridge 2 of the first contact bridge sub-assembly 1, 1a and the insulating body 10 apart. In the embodiment of FIGS. 6 and 7, the direction of action 44 of the spring element 6 of the first contact bridge sub-assembly 1,1a extends along the switching direction 18.

The insulating body 10 may further comprise a collar section 68 that may extend along the switching direction 18 and towards the first contact plane 30, 30a. In the shown embodiment, the spring element 6 of the first contact bridge sub-assembly 1, 1a at least partially coaxially surrounds the collar section 68 of the insulating body 10. The spring element 6 of the first contact bridge sub-assembly 1, 1a may be stabilized by the collar section 68 of the insulating body 10.

The second contact bridge sub-assembly 1, 1b shown in FIGS. 6 and 7 comprises a contact bridge 2 that has a Y-shape and comprises three legs 12. The contact bridge 2 of the second contact bridge 1, 1b sub-assembly is provided with exactly three switching contacts 4 spanning the second contact plane 30, 30b. In the shown embodiment, the switching contacts 4 are each arranged at a free end 32 of a different leg 12. As further shown in FIGS. 6 and 7, the legs 12 of the contact bridge 2 of the first contact bridge sub-assembly 1, 1a may be joined in a joining section 14. The joining section 14 of the contact bridge 2 of the second contact bridge sub-assembly 1, 1b may not, however, be offset relative to the second contact plane 30, 30b. In fact, the contact bridge 2 of the second contact bridge sub-assembly 1, 1b in the embodiment of FIGS. 6 and 7 extends straight along the second contact plane 30, 30b.

The second contact bridge sub-assembly 1, 1b may further comprise a spring assembly 7 having a spring element 6 which, in the embodiment shown, is a coil spring. One of the support sections 38 of the spring element 6 may be received and supported in a second circular recess 70 formed in the contact bridge 2 of the second contact bridge sub-assembly 1, 1b. The other support section 38 of the spring element 6 may rest on a second pressure plate 74, which, in the embodiment of FIGS. 6 and 7, may be arranged on a ground 76 of the collar section 68 of the insulating body 10. The ground 76 may extend substantially parallel to the first and second contact planes 30, 30a, 30b. The spring element 6 of the second contact bridge sub-assembly 1, 1b may, along the direction of action 44 of the spring element 6, push the contact bridge 2 of the second contact bridge sub-assembly 1, 1b and the insulating body 10 apart.

In the embodiment of FIGS. 6 and 7, the spring element 6 of the second contact bridge sub-assembly 1, 1b may be partially arranged within an opening 78 of the insulating body 10 enclosed by the collar section 68. The spring element 6 of the first contact bridge sub-assembly 1, 1a may further at least partially coaxially surround the spring element 6 of the second contact bridge sub-assembly 1, 1b.

The contact bridge assembly 46 shown in FIGS. 6 and 7 further comprises the contact bridge retainer 42. In the embodiment shown, the contact bridge retainer 42 is designed as an essentially U-shaped bracket that grips both contact bridges 2 on their sides provided with the switching contacts 4. As shown in FIGS. 6 and 7, the contact bridge retainer 42 may, for example, be attached to the first pressure plate 64 via locking sections 80. Similar to the embodiment of FIG. 4, the contact bridge retainer 42 may hold the spring elements 6 against their directions of action 44. This allows the spring elements 6 to be preloaded by adjusting the axial lengths 82 of the spring elements 6, which may be measured between two opposite ends 72 of a spring element 6.

In the embodiment shown in FIGS. 6 and 7, the contact bridges 2 of the first and second contact bridge sub-assemblies 1, 1a, 1b are intertwined, such that the joining sections 14 of both contact bridges 2 overlap each other along the switching direction 18. A first leg 12, 12a of the contact bridge 2 of the first contact bridge sub-assembly 1, 1a may be partially arranged between a second leg 12, 12e and a third leg 12, 12f of the contact bridge 2 of the second contact bridge sub-assembly 1, 1b, and a first leg 12, 12d of the contact bridge 2 of the second contact bridge sub-assembly 1, 1b may be partially disposed between a second 12, 12b and a third leg 12, 12c of the contact bridge 2 of the first contact bridge sub-assembly 1, 1b. In the embodiment shown in FIGS. 6 and 7, all legs 12 of both contact bridges 2 may have the same width 22.

In contrast to the embodiment shown in FIG. 2, the contact bridges 2 of the contact bridge assembly 46 shown in FIGS. 6 and 7 may have different outer dimensions 84. In the embodiment shown, the outer dimensions 84 may be measured along the longitudinal axes 16 of the legs 12. In particular, the contact bridge 2 of the first contact bridge sub-assembly 1, 1a may have a larger outer dimension 84 than the contact bridge 2 of the second contact bridge sub-assembly 1, 1b.

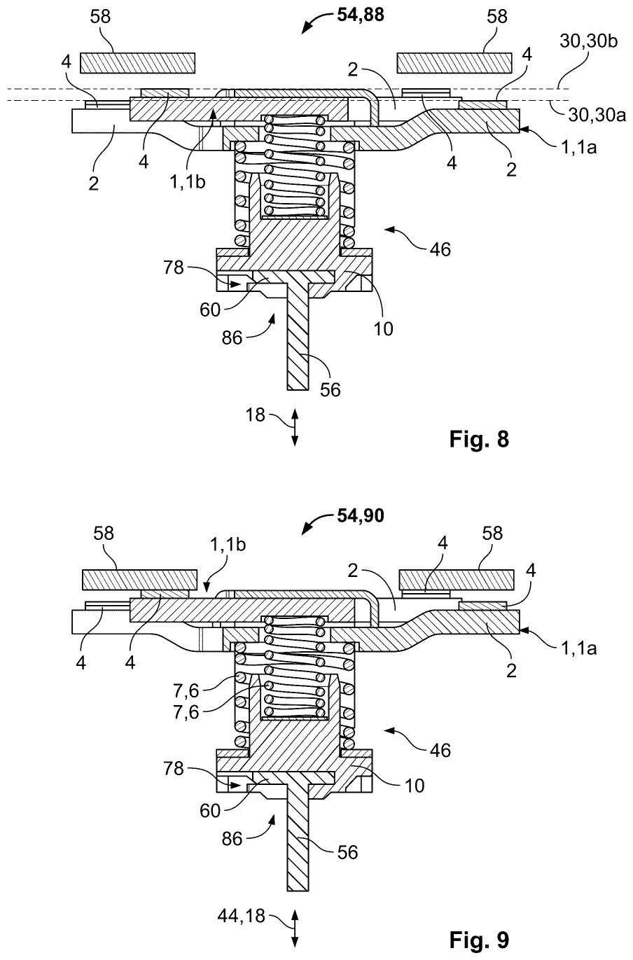

In the following, the function of an electric switching device 54 according to another embodiment is described with reference to FIGS. 8 to 10 just by way of example.

The electric switching device 54 shown in FIGS. 8 to 10 comprises the contact bridge assembly 46 according to the embodiment shown in FIGS. 6 and 7, stationary contacts 58 and the drive shaft 56. The drive shaft 56 may be connected to the insulating body 10 in a motion-transmitting manner. In the described embodiment, the head 60 of the drive shaft 56 may be mounted within a complementary formed opening 78 at a side 86 of the insulating body 10 facing away from the contact bridges 2.

The drive shaft 56 does not necessarily have to be embedded in the insulating body 10. In other embodiments, for example, the drive shaft 56 may directly be attached or connected to the at least one stiffening member 8 and/or to the at least one spring element 6 of the spring assembly 7. In these embodiments, no insulating body 10 may be present at all.

At the beginning, the electric switching device 54 may be in an open state 88. Both the first and the second contact planes 30, 30a, 30b are spaced apart from the stationary contacts 58 along the switching direction 18, such that there is no current flow between the stationary contacts 58 and the switching contacts 4. The electric circuit between the stationary contacts 58 and the switching contacts 4 is open. In the open state 88, the switching contacts 4 of the second contact bridge sub-assembly 1, 1b may be spaced apart shorter from the stationary contacts 58 along the switching direction 18 than the switching contacts 4 of the first contact bridge sub-assembly 1, 1a.

In order to switch the electric switching device 54 and close the electric circuit, the drive shaft 56 moves the contact bridges 2 jointly towards the stationary contacts 58, until the switching contacts 4 of the second contact bridge sub-assembly 1, 1b contact the stationary contacts 58 (see FIG. 9). In this partially closed state 90, the electric circuit between the switching contacts 4 of the second contact bridge sub-assembly 1, 1b and the stationary contacts 58 is already closed, whereas the switching contacts 4 of the first contact bridge sub-assembly 1, 1a are not yet in contact with the stationary contacts 58.

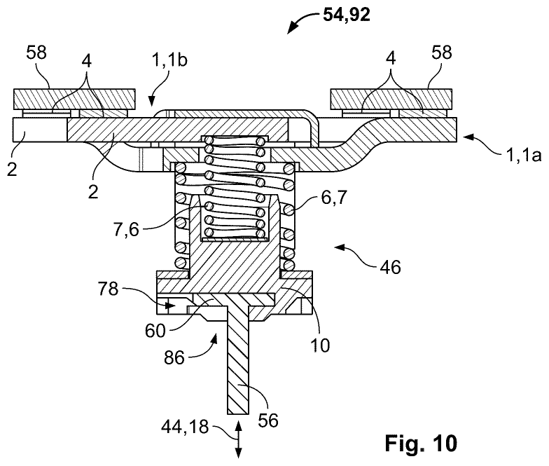

In order to also bring the switching contacts 4 of the first contact bridge sub-assembly 1, 1a into contact with the stationary contacts 58, the drive shaft 56 moves the contact bridge 2 of the first contact bridge sub-assembly 1, 1a further. In doing so, spring element 6 of the spring assembly 7 of the second contact bridge sub-assembly 1, 1b is compressed against its direction of action 44, whereby the switching contacts 4 of the second contact bridge sub-assembly 1, 1b are pressed firmly and securely against the stationary contacts 58. Once the switching contacts 4 of the first contact bridge sub-assembly 1, 1a are also in contact with the stationary contacts 58, the electric switching device 54 is in a fully closed state 92 (see FIG. 10). As soon as the switching contacts 4 of the first contact bridge sub-assembly 1, 1a are in contact with the stationary contacts 58, the spring element 6 of the spring assembly 7 of the first contact bridge sub-assembly 1,1a is compressed against its direction of action 44, as a result of which the switching contacts 4 of the first contact bridge sub-assembly 1, 1a are pressed firmly and securely against the stationary contacts 58.

In order to press the contact bridges 2 against the stationary contacts 58 with different forces, the spring elements 6 of the first and second contact bridge sub-assembly 1, 1a, 1b may have different spring stiffnesses. For example, the spring element 6 of the contact bridge sub-assembly 1, whose contact plane 30 is spaced closer from the stationary contacts 58 in the open state 88 may have a greater spring stiffness than the spring element 6 of the contact bridge sub-assembly 1 whose contact plane 30 is spaced further from the stationary contacts 58 in the open state 88.

To switch the electric switching device 54 back to the open state 88, i.e. to open the electric circuit, the drive shaft 56 moves the contact bridges 2 jointly along the switching direction 18 and away from the stationary contacts 58, until all switching contacts 4 are again spaced apart from the stationary contacts 58.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Contact bridge subassembly for an electric switching device comprising:
a contact bridge that is movable along a switching direction,
wherein exactly three switching contacts are arranged on the contact bridge, the three switching contacts spanning a contact plane.

2. Contact bridge subassembly according to claim 1,
wherein the contact bridge comprises at least three legs, and wherein each of the switching contacts is arranged on a different leg.

3. Contact bridge subassembly according to claim 2,
wherein at least two of the legs are joined with each other respectively in at least one joining section.

4. Contact bridge subassembly according to claim 3,
wherein the at least one joining section is offset along the switching direction relative to the contact plane.

5. Contact bridge subassembly according to claim 1,
wherein the contact bridge subassembly comprises a spring assembly which supports the contact bridge, the spring assembly comprising at least one spring element.

6. Contact bridge subassembly according to claim 5,
wherein the spring assembly comprises at least two spring elements that are deflectable independent of each other.

7. Contact bridge subassembly according to claim 5,
wherein the contact bridge subassembly comprises at least one stiffening member for supporting the spring assembly, and
wherein each spring element of the spring assembly comprises two support sections at opposite ends, one support section being located at the contact bridge and the other support section being connected to the stiffening member.

8. Contact bridge subassembly according to claim 5,
comprising at least one contact bridge retainer adapted for holding the contact bridge against the direction of action of the spring assembly.

9. Contact bridge subassembly according to claim 5,
wherein the contact bridge comprises at least three legs, and wherein each of the switching contacts is arranged on a different leg;
wherein at least one of the at least three legs is supported by at least one spring element of the spring assembly.

10. Contact bridge subassembly according to claim 1,
wherein the contact bridge has a Y-shape.

11. Contact bridge assembly comprising:
a first contact bridge subassembly and a second contact bridge subassembly, the first and second contact bridge assemblies each including a contact bridge that is movable along a switching direction, wherein exactly three switching contacts are arranged on the contact bridge, the three switching contacts spanning a contact plane.

12. Contact bridge assembly according to claim 11,
wherein the contact bridges of the first and the second contact bridge subassemblies are interlaced.

13. Contact bridge assembly according to claim 11,
wherein a leg of the contact bridge of the first contact bridge subassembly is at least sectionally arranged between two legs of the contact bridge of the second contact bridge subassembly.

14. Contact bridge assembly according to claim 11,
wherein at least one spring element supports the contact bridges of both the first and the second contact bridge subassembly.

15. Contact bridge assembly according to claim 11,
wherein each of the contact bridges of the first and the second contact bridge assemblies comprises at least three legs, and wherein each of the switching contacts is arranged on a different leg.

16. Contact bridge assembly according to claim 11,
wherein each of the first and second contact bridge subassemblies comprises a spring assembly which supports the corresponding contact bridge, the spring assembly comprising at least one spring element.

17. Contact bridge assembly according to claim 16,
wherein the spring assembly comprises at least two spring elements that are deflectable independent of each other.

18. Contact bridge assembly according to claim 16,
wherein the first and second contact bridge subassemblies each comprises at least one stiffening member for supporting the corresponding spring assembly, and
wherein each spring element of the spring assembly comprises two support sections at opposite ends, one support section being located at the contact bridge and the other support section being connected to the stiffening member.

19. Contact bridge assembly according to claim 11,
wherein the contact bridges of the first and second contact bridge subassemblies has a Y-shape.

20. Electric switching device, comprising
a first contact bridge subassembly and a second contact bridge subassembly, the first and second contact bridge assemblies each including a contact bridge that is movable along a switching direction, wherein exactly three switching contacts are arranged on the contact bridge, the three switching contacts spanning a contact plane;
a drive shaft adapted for moving the contact bridges jointly along the switching direction; and
stationary contacts that are configured to be contacted by the switching contacts.
